(19) United States
(12) Patent Application Publication
(10) Pub. No.: US 2024/0151292 A1
(43) Pub. Date: May 9, 2024

(54) Magnetorheological Fluid Damping System

(71) Applicant: United States of America, as represented by the Secretary of the Navy, Patuxent River, MD (US)

(72) Inventor: Jan M. Kasprzak, Lexington Park, MD (US)

(21) Appl. No.: 17/981,735

(22) Filed: Nov. 7, 2022

(51) Int. Cl. F16F 9/53

(52) U.S. Cl. CPC F16F 9/537; F16F 2224/045; F16F 2226/02

(57) ABSTRACT

A magnetorheological fluid damping system for shock and vibration attenuation, which comprises of an outer cylinder, a piston cylinder partially disposed within the outer cylinder, a metering pin disposed within the outer cylinder and partially disposed within the piston cylinder, and an electromagnetic valve having two opposite ends and attached to the piston cylinder. The electromagnetic valve is completely disposed within the outer cylinder. The electromagnetic valve comprises of valve casing with a cavity, an annular electric coil disposed within the cavity of the valve casing, two layers of cladding attached on the opposite ends of the electromagnetic valve, and magnetorheological fluid disposed within the outer cylinder. The piston cylinder and metering pin are partially immersed within the magnetorheological fluid, while and the valve casing is attached to the piston cylinder.

### STATEMENT OF GOVERNMENT INTEREST

The invention described herein may be manufactured and used by or for the Government of the United States of America for governmental purposes without payment of any royalties thereon or therefor.

### BACKGROUND

Traditional magnetorheological fluid (MRF) dampers and valves include fluid flow gaps that are relatively small. As a result, these designs are very efficient because there is very little magnetic flux leakage that occurs in the magnetic circuit within those dampers. Thus, no form of magnetic insulation (a barrier material that resists magnetic flux) is needed to achieve adequate performance for traditional MRF dampers, which are increasingly being incorporated in production automobiles. However, for applications involving larger fluid flow gaps, such as on MRF shock struts for aircraft landing gear, magnetic flux leakage may be substantial. This magnetic flux leakage would introduce non-linearity into the behavior of an aircraft MRF device, and would make the device less efficient because of the additional power needed to operate the device with the magnetic flux leakage. Magnetic insulation significantly improves the performance of MRF valves with large fluid flow gaps by increasing resistance to magnetic flux leakage, thereby, concentrating more flux through the fluid flow gap while reducing power requirements. Use of magnetic insulation can be found in U.S. Pat. No. 6,390,252, granted on May 21, 2002, entitled “Magnetorheological Fluid Damper With Optimum Damping,” and invented by Namuduri et al. (which is not admitted to be prior art). The Patent describes non-magnetic end plates on an otherwise traditional MRF damper design to achieve a magnetic insulating effect. U.S. Pat. No. 6,390,252 describes the mode of attachment to be brazing or welding. However, a more efficient method of attachment, which is not taught or suggested by U.S. Pat. No. 6,390,252, is to permanently deposit the non-magnetic material onto the MRF valve core material using an additive manufacturing process.

### SUMMARY

The present invention is directed to a magnetorheological fluid damping system with the needs enumerated above and below.

The present invention is directed to a magnetorheological fluid damping system for shock and vibration attenuation, the magnetorheological fluid damping system comprising of: an outer cylinder; a piston cylinder partially disposed within the outer cylinder; an electromagnetic valve having two opposite ends and attached to the piston cylinder, the electromagnetic valve completely disposed within the outer cylinder, the electromagnetic valve comprising of: a valve casing with a cavity, the valve casing attached to the piston cylinder; an annular electric coil disposed within the cavity of the valve casing; two layers of cladding attached on the opposite ends of the electromagnetic valve; a metering pin disposed within the outer cylinder, disposed within the electromagnetic valve, and partially disposed within the piston cylinder; and, magnetorheological fluid disposed within the outer cylinder and exterior to the metering pin, the piston cylinder partially immersed within the magnetorheological fluid.

It is a feature of the present invention to provide a form of magnetic insulation to increase resistance for leaking magnetic flux within a magnetorheological fluid damping system.

It is a feature of the present invention to provide a magnetorheological fluid damping system with improved wear protection, increased efficiency, and improved performance over currently used damping systems. The immediate benefit of the invention is to minimize magnetic flux leakage across relatively large fluid gaps or when operating at relatively high magnetic flux densities. Reducing the magnetic flux leakage within a magnetorheological fluid damping system leads to a significant increase of the magnetic intensity across the fluid gap, which proportionally increases the yield stress of the magnetorheological fluid within the gap. It follows that the damping load imparted by the magnetorheological fluid damping system increases by the same proportion. Minimizing the magnetic flux leakage also reduces the peak magnetic flux density for an applied magnetomotive force, which allows for more performance to be realized from the system in the linear range of the system response before elements of the magnetic circuit reach magnetic flux density saturation points.

It is a feature of the present invention to provide a magnetorheological fluid damping system that has decreased inductance of the magnetic circuit, which decreases magnetorheological fluid damping system response time and the power required to achieve a desired electromagnet coil current.

It is a feature of the present invention to provide a magnetorheological fluid damping system that provides a protective barrier for MRF valves, protecting the mechanically soft electromagnet core materials from wear and handling damage that would otherwise impact the magnetic flux path.

It is a feature of the present invention to provide a magnetorheological fluid damping system that allows a designer to optimize the fluid flow path internal to the magnetorheological fluid damping system without affecting magnetic circuit performance. The present invention, but without limitation, distinguishes itself over prior art by achieving the previously mentioned benefits by applying the magnetically insulating material, which could be referred to as a barrier or a cladding, with the use of additive manufacturing technologies. This allows the magnetic insulation to be permanently bonded to a magnetic core material, which reduces part count for a magnetorheological fluid damping system, and eliminates the need to use fasteners or other means to attach the insulation that would negatively impact the performance of the magnetic circuit and the flow of the magnetorheological fluid.

### DRAWINGS

These and other features, aspects and advantages of the present invention will become better understood with reference to the following description and appended claims, and accompanying drawings wherein:

FIG. 1 is a cross sectional view of an embodiment of the magnetorheological fluid damping system; and,

FIG. 2 is a cross sectional view of an embodiment of the magnetorheological fluid damping system without cladding.

### DESCRIPTION

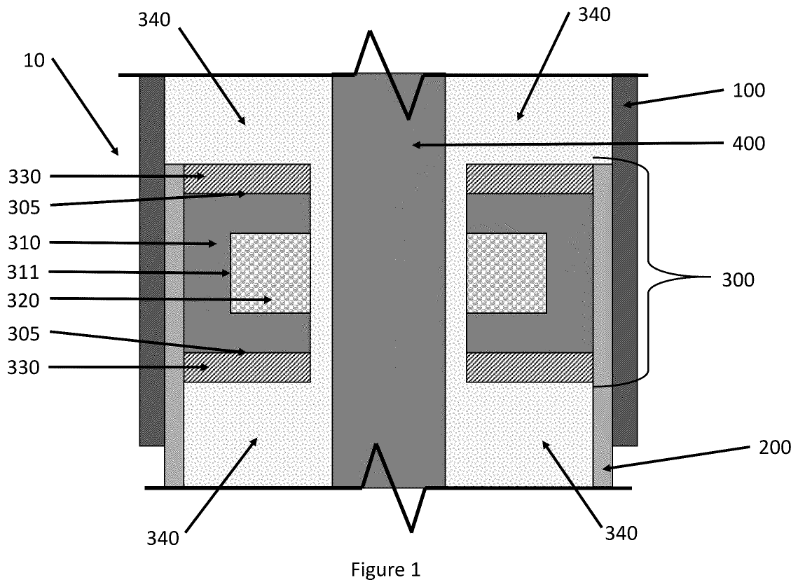

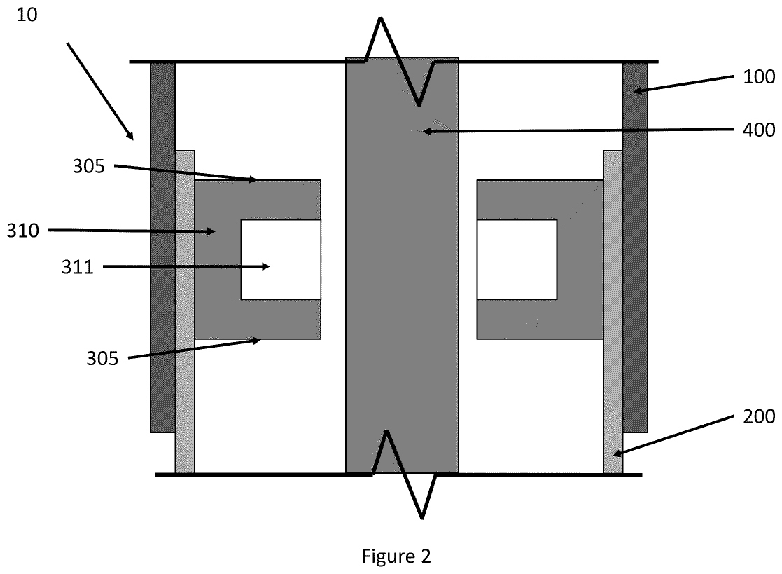

The preferred embodiments of the present invention are illustrated by way of example below and in FIGS. 1-2. As shown in FIG. 1, a magnetorheological fluid damping system 10 for shock and vibration attenuation comprises of an outer cylinder 100, a piston cylinder 200 partially disposed within the outer cylinder 100, and an electromagnetic valve 300 having two opposite ends 305 and attached to the piston cylinder 200. The electromagnetic valve 300 is completely disposed within the outer cylinder 100. The electromagnetic valve 300 comprises of a valve casing 310 with a cavity 311, an annular electric coil 320 disposed within the cavity 311 of the valve casing 310 (which can be cylindrical), at least two layers of cladding 330 attached on the opposite ends 305 of the electromagnetic valve 300, a metering pin 400 (which optionally can be tapered or contoured) disposed within the outer cylinder 100, disposed within the electromagnetic valve 300, and partially disposed within the piston cylinder 200, and magnetorheological fluid 340 disposed within the outer cylinder 100. The piston cylinder 200, the electromagnetic valve 300, and the metering pin 400 are partially immersed within the magnetorheological fluid 340. The valve casing 310 is attached to the piston cylinder 200.

In the description of the present invention, the invention will be discussed in a military environment; however, this invention can be utilized for any type of application that requires use of a damping system.

Similar to all electromagnetic machines, all magnetorheological fluid (MRF) devices leak magnetic flux both internally and externally. While well designed MRF devices leak less, the flux leakage never entirely disappears. Specifically to MRF devices, such as MRF dampers and MRF shock struts, magnetic flux leakage results in less magnetic intensity delivered to the designed MRF gap within an electromagnetic valve 300. This results in a damping performance decrease and increases the electrical power requirements for either of those devices. This magnetic flux leakage is driven by the physics of magnetism and the tendency for magnetic flux to flow towards the path of least resistance. A primary purpose of this invention is to introduce a form of magnetic insulation to increase resistance for leaking magnetic flux.

Magnetic permeability is, but without limitation, a measure of how much attraction exists between a material and a magnetic field. The inverse of permeability can be considered how resistive a material is to a magnetic flux. Therefore, a material that possesses a high permeability is less resistive to magnetic flux, and vice versa. Relative permeability is a unitless value that is often used for convenience; it is the actual permeability measured for a material normalized by the permeability of free space (i.e. perfect vacuum). Much like any other electromagnetic devices, the amount of magnetic flux leakage depends on the permeabilities of the core materials and the surrounding environment. More magnetic flux leakage will occur if the core material has a relatively low permeability, and/or if the surrounding environment has a relatively high permeability.

The soft ferromagnetic materials used for electromagnet cores (for example, but without limitation, low carbon steels, pure iron, silicon irons, etc.) typically exhibit relative permeabilities ranging from 100 to 10,000. Paramagnetic materials (for example, but without limitation, air, oil, aluminum, gold, etc.) exhibit relative permeabilities that are close to unity (i.e. approximately equal to that of free space). MRF's primarily contain a ferromagnetic material (carbonyl powder or similar material) suspended within a paramagnetic carrier fluid (such as, but without limitation, hydraulic oil). As a result, the relative permeability of an MRF falls between the normal values of a paramagnetic material and a ferromagnetic material and typically ranges from five (5) to twenty (20).

Within an MRF device, the MRF occupies most of the space around the magnetic circuit formed by the electromagnetic valve 300, which makes the devices susceptible to higher levels of magnetic flux leakage. This can be especially true when damping performance must be maximized, which would likely be the case for aerospace applications. Attempting to force large magnetic flux densities through an MRF gap increases the local resistance to flux, which increases the amount of flux that will leak outside of the MRF gap to the upstream and downstream MRF chambers. This problem is worse in MRF shock struts that utilize a metering pin 400. In this configuration, because the MRF gaps are closer to the centerline axis of the device, the cross-sectional area for magnetic flux is small when compared to a traditional MRF valve, which causes the flux density in the gaps to be much higher than in a similarly sized MRF damper.

The present invention seeks to address this issue by introducing a barrier material or cladding 330 (as shown in FIG. 1) in between the electromagnetic core material and the MRF. The cladding 330 needs to have a magnetic permeability that is lower than that of the MRF 340. If that is achieved, the cladding 330 will add resistance to magnetic flux leakage, which provides “insulation” in the same way that a nonconductive material with high electrical resistance (for example, but without limitation, plastic or rubber), can insulate an electrical conductor. And similar to electrical insulation, a thicker barrier material for MRF device applications results in higher resistance and reduced magnetic flux leakage.

This barrier material or cladding 330 can be introduced in many ways, but one method is to apply it in the form of a permanently attached coating or cladding 330 onto the electromagnetic core material or electromagnetic valve 300, specifically the valve casing 310. This eliminates the need for a form of mechanical attachment, which will likely be advantageous in the volumetrically constricted damper and shock strut applications. Mechanical fastening methods would also alter the geometry of the electromagnetic core material, which affects the magnetic flux flowing through the material. Analogously, this is very similar to what would happen if one introduced an obstructing solid object or boundary into a flowing fluid. Having the barrier material attached as a cladding 330 eliminates the need to alter the core material, which results in the core material behaving closer to analytical prediction, and results in performance improvement in the final application.

In addition to magnetic flux improvements, which is directly related to MRF device damping performance, the cladding 330 utilized by the present invention offers several other benefits, which makes it truly multifunctional. From an electrical power standpoint, less magnetic flux leakage also means more damping performance with a quicker response time for a given electric coil 320. This cladding 330 can also have a positive impact on fluid flow within the MRF device or system. The cladding 330 or coating described in the present invention may optionally have a simple geometry in the form of a short cylinder or ring. However, in the preferred embodiment, the cladding 330 is applied with a relatively high thickness to allow the formation of an entrance geometry that is favorable to fluid flow. This is very important for MRF shock struts, where a rounded entrance to an orifice or annulus is typically required. For MRF damper applications, the cladding 330 can also be used as a bearing material, above and/or below an MRF valve 300, to keep the MRF valve 300 concentric within the damper. In both applications, this cladding 330 eliminates the need to complicate the geometry of the core material to accommodate fluid flow, which results in a more predictable magnetic circuit.

Additional benefits of this approach include wear protection for the soft iron/steel materials typically used for magnetic applications. From a production standpoint, this cladding concept reduces part count as opposed to alternative methods of attaching a magnetically insulating barrier material. And from a maintenance perspective, the cladding 330 offers a form of wear and damage protection that can be rebuilt. In the event that some form of damage occurs, as long as the damage does not reach to core material, the damaged cladding 330 can be removed/blended, and new cladding 330 can be deposited to restore the original geometry of the cladding 330. This may be a way to help keep MRF devices in service for longer periods of time.

The cladding 330 described in the present invention can be applied to new or existing MRF dampers or shock struts. The cladding 330 may be applied, but without limitation, with an additive manufacturing (AM) technology, such as, but without limitation, Directed Energy Deposition (DED) technologies, Cold-Spray Deposition (CSD) technologies (including laser-assisted cold-spray), Ultrasonic Additive Manufacturing (UAM) technologies, Chemical Vapor Deposition (CVD) technologies, and depositions made with Friction-Stir Welding (FSW) technologies. Other processing techniques could also be used. Of the AM technologies listed, CSD offers several advantages. CSD is a solid-state process (i.e. no material in process is melted) that can quickly produce a thick coating/cladding 330 with high hardness. Also, the CSD process imparts minimal changes to the substrate material. Thus, in the preferred embodiment of the invention, the multifunctional coating or cladding 330 is deposited with a traditional CSD process, without the need for supplemental laser heating that is provided by more advanced processes, such as Laser-Assisted Cold Spray.

The cladding 330 may be applied to new over-sized stock material (e.g. cylindrical rod stock or thick cylindrical tube stock) that will eventually make up the valve casing 310. The stock material should be made from a soft ferromagnetic material that is well-suited for electromagnet applications that require high magnetic flux saturation points (for example, but without limitation, pure iron, low-carbon steel, iron-cobalt alloys such as Hiperco-50™, etc.). As previously described, the cladding 330 material to be applied, especially with CSD, has a magnetic permeability that is lower than that of the MRF 340. Paramagnetic (non-magnetic) materials (e.g. air, water, aluminum, titanium, etc.) have permeabilities that are approximately equal to that of free space (perfect vacuum), which makes them well-suited to function as magnetic insulation for this invention. Preferably, the cladding 330 material should be a high-strength aluminum, such as a 7075 alloy, which offers the following advantages: low density, relatively high strength and durability, and easy to machine.

Prior to application of the cladding 330, the surfaces of the stock material or valve casings 310 of the EMV 300 that will receive the cladding 330 require surface preparation. This preparation should, at minimum, but without limitation, include machining to smooth the surface to an acceptable finish, lightly abrading the surface, and wiping the surface with a cleaning agent (such as, but without limitation, isopropyl alcohol). The stock material or valve casing 310 should be processed with CSD shortly after surface preparation to minimize the chance for contamination of the surface, which can impact cladding 330 bond strength. CSD process parameters (carrier gas, spraying velocity, spraying angle relative to the surface of the stock material, nozzle translational speed, etc.) should be carefully tuned for specific materials in trial runs. Specifically, trial runs should evaluate, at minimum, cladding 330 bond strength (shear and normal) and cladding 330 porosity. The cladding 330 provides the most benefit when it is applied to one or both flat faces of a cylindrical stock material, in this case opposite ends of the valve casing 310. Additional benefits may be realized if the cladding 330 is applied in the same fashion to the round surface of the cylindrical stock material or valve casing 310; however, this will likely require a more complicated manufacturing processes to successfully apply the cladding 330 to the stock material.

CSD processes typically cannot deposit a cladding 330 material to an acceptable geometric condition. With a traditional 2-axis or 3-axis spraying setup, a CSD process typically cannot build a deposit with a square edge. Instead, the edge of the deposit tapers at approximately a 45 degree angle from the outer edges of the stock material outer surface. Thus, the radius of the stock material must be larger than the final component to allow the final component to be cut from the sprayed stock material. At minimum, the radius of the stock material should be greater than the sum of the following: the radius of the final component, the desired thickness of the applied cladding 330, and additional margin to account for the surface roughness of the deposited cladding 330. CSD cladding 330 typically exhibit a rough wavy top surface, and machining off 0.063 inches is often enough to remove top surface roughness.

In the preferred embodiment, no heat treatment or any other post-processing is required to achieve a sufficient bond between the stock material and the CSD cladding 330. After CSD, the cladded stock material can be immediately moved into final machining phases. Final machining steps should include, but without limitation, cutting away the rough cold-sprayed top surface, turning down the outer diameter to remove the tapered cladding 330 region, and then machining the remaining geometrical featured of the MRF valve 300.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A magnetorheological fluid damping system for shock and vibration attenuation, the magnetorheological fluid damping system comprising of:
an outer cylinder;
a piston cylinder partially disposed within the outer cylinder;
an electromagnetic valve having two opposite ends and attached to the piston cylinder, the electromagnetic valve completely disposed within the outer cylinder, the electromagnetic valve comprising of:
a valve casing with a cavity, the valve casing attached to the piston cylinder;
an annular electric coil disposed within the cavity of the valve casing; and
two layers of cladding attached on the opposite ends of the electromagnetic valve; and,
a metering pin disposed within the outer cylinder, disposed within the electromagnetic valve, and partially disposed within the piston cylinder; and,
magnetorheological fluid disposed within the outer cylinder, the piston cylinder and the metering pin partially immersed within the magnetorheological fluid.

2. The system of claim 1, wherein the cladding has a magnetic permeability lower than the magnetorheological fluid.

3. The system of claim 2, wherein during manufacture, prior to application of the cladding, the opposite ends of the electromagnetic valve are prepared utilizing the following process: machining to smooth the surface, lightly abrading the surface, and wiping the surface with a cleaning agent.
